(19) United States
(12) Patent Application Publication
(10) Pub. No.: US 2026/0014764 A1
(43) Pub. Date: Jan. 15, 2026

(54) FRAME FOR EYEGLASSES AND METHOD FOR PROVIDING THE FRAME

(71) Applicant: LUXOTTICA S.R.L., AGORDO (IT)

(72) Inventors: Etienne PIANTANIDA, BELLUNO (IT); Gianluca FANDELLA, BELLUNO (IT); Tommaso ONGARELLO, BELLUNO (IT)

(21) Appl. No.: 18/993,849

(22) PCT Filed: Jun. 29, 2023
(86) PCT No.: PCT/EP2023/067884

§ 371 Date: Jan. 13, 2025

(30) Foreign Application Priority Data
Jul. 15, 2022 (IT) 102022000014878

(51) Int. Cl. B29D 12/02; G02C 5/00

(52) U.S. Cl. CPC B29D 12/02; G02C 5/008

(57) ABSTRACT

A frame for eyeglasses, provided by means of at least one sheet of photoacetate provided with areas which comprise photochromatic pigments and areas lacking photochromatic pigments, organized so as to form geometries, patterns, designs and images desired by the manufacturer.

The present invention relates to a frame for eyeglasses and to a corresponding method for providing the frame. More particularly, the invention relates to a frame for eyeglasses made of photochromatic acetate.

As is known, frames for eyeglasses can be made of acetate, which is an easily workable material and therefore optimal for the provision of eyeglasses, since it can be milled, polished and machined to create ever-changing and trendy frames with infinite color combinations.

Acetate is a product obtained from cellulose, which is an organic fiber. The starting material from which acetate is obtained is cotton.

In order to produce the frames, cellulose acetate is transformed and processed into rigid sheets. The acetate sheets are then cut and milled in order to obtain the frames of the eyeglasses according to the desired shapes.

Photochromatic acetates are known which contain a photochromatic pigment which, in the presence of sunlight, allows to reveal colorings that would otherwise not be visible.

The effect is reversible, since when the material is sheltered from sunlight the coloring changes and the color becomes neutral again, i.e., not activated.

However, the production processes for frames made of photochromatic acetate of a known type provide that the photochromatic effect is an effect that can be achieved absolutely uniformly. Adding photochromatic pigment, which is dispersed in the material that constitutes the frame, gives rise to homogeneous, single-color, ever-changing colorings that however are not precisely defined and, above all, cannot be provided according to particular geometries, patterns or images.

This means that with the processes of the known type it is not possible to obtain frames made of acetate that have a coloring with well-defined, desired and also possibly repeatable geometric designs, patterns, images, details.

The aim of the present invention is to provide a frame for eyeglasses made of photochromatic acetate which can have well-defined, desired and also possibly repeatable geometries, designs, patterns or images and can be provided in multiple different colors.

Within this aim, an object of the present invention is to provide a frame for eyeglasses that can be provided with the conventional so-called wet block technology, while allowing to obtain desired well-defined geometries, patterns, designs or images.

Not least object of the present invention is to provide a frame for eyeglasses and a corresponding method that are highly reliable, relatively easy to provide and at competitive costs.

This aim and these and other objects which will become better apparent hereinafter are achieved by a frame for eyeglasses, characterized in that it is provided by means of a sheet of photoacetate, said sheet of photoacetate being provided with areas which comprise at least one photochromatic pigment and areas lacking photochromatic pigments, which are organized so as to form geometries, patterns, designs and images that are desired by the manufacturer.

Further characteristics and advantages of the invention will become better apparent from the description of a preferred but not exclusive embodiment, of the frame for eyeglasses and of the corresponding method according to the present invention, illustrated by way of non-limiting example in the accompanying drawings, wherein:

FIG. 1 is a schematic perspective view, on the left, of blocks without and with photochromatic pigments, in the presence of artificial light, and on the right of the same blocks in the presence of sunlight, in accordance with the method according to the present invention;

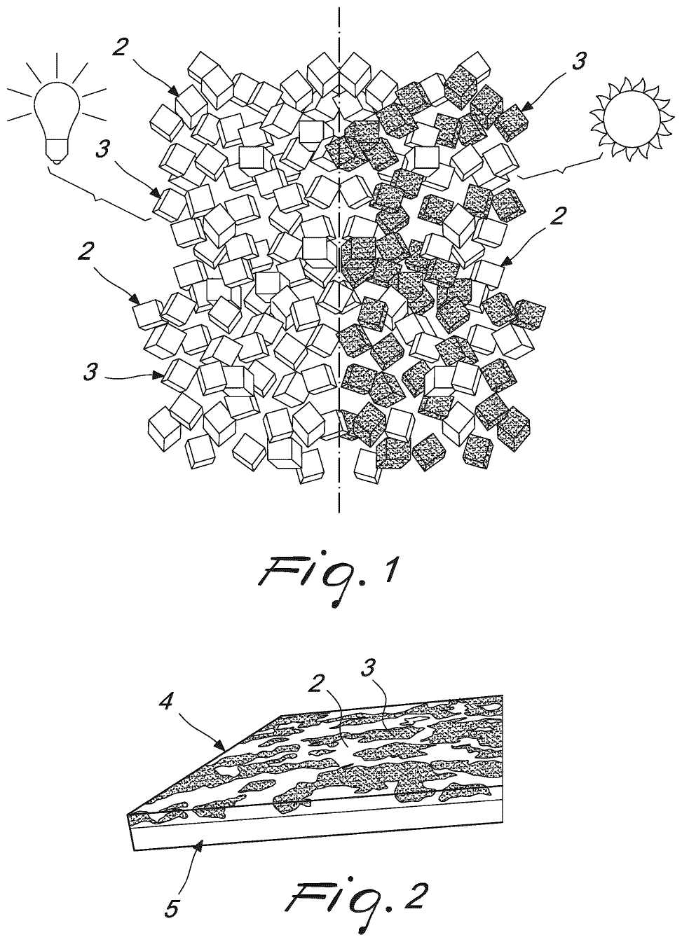

FIG. 2 is a view of a sheet of acetate provided with the method according to the present invention, coupled to a single-color slice of acetate;

FIG. 3 is a view of a frame for eyeglasses provided according to the present invention and exposed to artificial light;

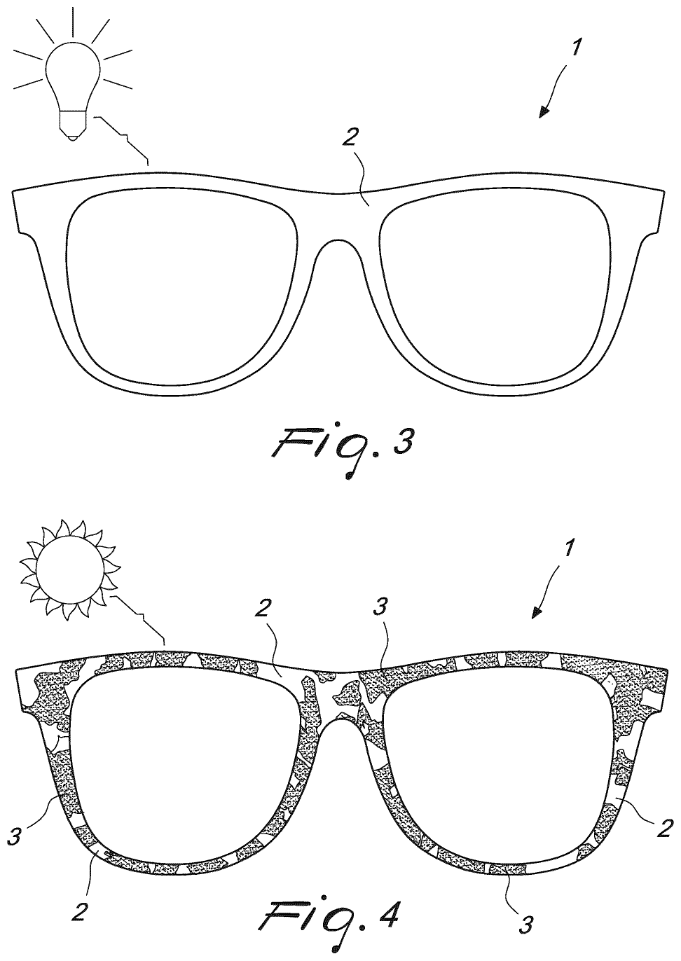

FIG. 4 is a view of a frame for eyeglasses provided according to the present invention and exposed to sunlight.

The frame for eyeglasses according to the present invention, generally designated by the reference numeral 1, is made of photochromatic acetate and the method for providing it is the so-called wet block method.

In order to obtain the acetate paste, the polymer, the plasticizer and any additives are mixed in the presence of a solvent.

Then, by means of a calender, at least one photochromatic pigment is combined with the acetate paste in order to obtain sheets of photochromatic acetate.

At least one block with photochromatic pigments is obtained from the sheets mentioned above.

The sheets can be cut by means of a cube forming device so as to obtain a plurality of photochromatic blocks (cubes) 3.

In a similar manner, an acetate paste is obtained, again by means of a wet block process, without adding photochromatic pigments.

At least one block 2 without photochromatic pigments is obtained from the sheets mentioned above.

The sheets can also, in this case, be cut by means of a cube forming device in order to obtain acetate blocks (cubes) 2 without pigments, i.e., transparent blocks, but they can also be colored with a non-photochromatic pigment.

FIG. 1 shows, on the left, acetate blocks 2 without photochromatic pigments and acetate blocks 3 with photochromatic pigments, in the presence of artificial light, while on the right the same blocks are shown in the presence of sunlight.

The blocks 3 with photochromatic pigments and the blocks 2 without photochromatic pigments are then transferred into a mold, conveniently combining, according to the desired geometries, the blocks 3 with photochromatic pigments with the blocks 2 without photochromatic pigments, in order to obtain, by means of pressure and temperature, a single block.

It is possible, therefore, to join more than one block 2 without photochromatic pigments with a block 3 with photochromatic pigments and/or join more than one block 2 without photochromatic pigments with more than one block 3 with photochromatic pigments, or any other combination thereof, in order to obtain a single block.

The single block is then sliced and slices 4 thus obtained are left to dry in an oven.

In a particular embodiment, the slices 4 of photochromatic acetate are glued onto single-color slices 5 of acetate, in order to obtain the desired effects, for example a particular color when the frame is not “activated” by the light (see FIG. 2).

Therefore, the blocks 3 with the photochromatic pigments and the blocks 2 without photochromatic pigments obtained by means of the wet block process are substantially combined according to the desired geometries, so as to provide geometries, patterns, designs and images chosen by the manufacturer.

Therefore, the photochromatic pigments are not dispersed uniformly in the acetate material from which the frame 1 is made, but are organized or in any case arranged so as to be able to highlight specific geometries, patterns, designs and images.

The invention also relates, therefore, to a frame 1 for eyeglasses made of photochromatic acetate, in which the photochromatic pigments are arranged and organized according to a very specific aesthetic choice, desired by the manufacturer, in order to provide appropriate patterns among these for example also the one known as “tortoiseshell”.

FIG. 3 shows a frame provided according to the present invention exposed to artificial light, while FIG. 4 shows the same frame exposed to sunlight, with activation of the photochromatic pigments.

In practice it has been found that the frame for eyeglasses and the corresponding method fully achieve the intended aim and objects, since it is possible to obtain a frame with geometric designs, patterns and the like, provided by means of photochromatic pigments arranged in a conveniently defined manner in the acetate paste from which the frame is made.

The frame and the method thus conceived are susceptible of numerous modifications and variations, all of which are within the scope of the accompanying claims.

All the details may furthermore be replaced with other technically equivalent elements.

In practice, the materials used, as well as the contingent shapes and dimensions, may be any according to the requirements and the state of the art.

The disclosures in Italian Patent Application No. 102022000014878 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1.-7. (canceled)

8. A frame for eyeglasses, provided by means of at least one sheet of photoacetate, said sheet of photoacetate being provided with areas which comprise at least one photochromatic pigment and areas lacking photochromatic pigments, which are arranged so as to form geometries, patterns, designs and images that are desired by the manufacturer.

9. The frame for eyeglasses according to claim 8, wherein said areas with photochromatic pigments and said areas without photochromatic pigments are obtained by means of photochromatic acetate blocks and non-photochromatic acetate blocks arranged according to a desired aesthetic choice.

10. A method for providing frames for eyeglasses, comprising the steps of:
preparing an acetate paste;
adding at least one photochromatic pigment to said acetate paste, in order to obtain sheets of photochromatic acetate;
preparing an acetate paste without photochromatic pigments and obtaining acetate sheets without photochromatic pigments;
obtaining, from said acetate sheets with at least one photochromatic pigment and without photochromatic pigment, at least one acetate block with photochromatic pigment and at least one acetate block without photochromatic pigment;
arranging said block of photochromatic acetate and said block of acetate without photochromatic pigment in a mold so as to define desired geometries, patterns, designs and images;
applying pressure and temperature to said mold in order to obtain a single block;
slicing said single block and leaving slices thus obtained to dry in an oven;
obtaining frames of eyeglasses according to desired shapes from said dried slices.

11. The method according to claim 10, further comprising the steps of:
cutting said sheets of photochromatic acetate by means of a cube forming device in order to produce a plurality of said blocks of photochromatic acetate;
cutting said sheets of acetate without pigment by means of said cube forming device in order to obtain a plurality of said acetate blocks without photochromatic pigment.

12. The method according to claim 11, further comprising a step of joining more than one block without photochromatic pigments with a block with photochromatic pigments.

13. The method according to claim 11, further comprising a step of joining more than one block without photochromatic pigments with more than one block with photochromatic pigments.

14. The method according to claim 10, wherein said block without photochromatic pigments is provided by means of non-photochromatic colored pigments.
